(19) United States
(12) Patent Application Publication
(10) Pub. No.: US 2013/0111952 A1
(43) Pub. Date: May 9, 2013

(54) RINGS HAVING AN ANNULAR OPENING OF VARIABLE SIZE AND ASSOCIATED METHODS FOR MAKING AND USING THE SAME

(71) Applicant: Jong Dae Ra, Louisville, KY (US)

(72) Inventor: Jong Dae Ra, Louisville, KY (US)

(21) Appl. No.: 13/292,179

(22) Filed: Nov. 9, 2011

(51) Int. Cl. A44C 9/02; B23P 17/04

(52) U.S. Cl. 63/6; 29/428

(57) ABSTRACT

Rings having variable sized annular openings and methods for making and using such rings are disclosed. A ring is disclosed that includes a ring shank having inner and outer circumferential surfaces, where the inner circumferential surface defines a maximum circumference of an annular opening of the ring shank, and a clasp that includes a first end portion hingedly connected to the ring shank and a second end portion. The clasp is rotatable between a secured position in which the second end portion is securably engaged with the ring shank and a plurality of unsecured positions. The clasp may include an arcuate portion and at least one protrusion that narrows a cross-sectional area of the annular opening when the second end portion is securably engaged to the ring shank.

### BACKGROUND

There are several disadvantages associated with rings having annular openings of a fixed diameter or size. The width of a digit of a hand typically varies along the length of the digit, with the cross-sectional circumference of the digit generally being larger at those portions that are more proximal to the palm. A ring having an annular opening of a fixed size is generally chosen so that the ring fits snugly around some portion of the proximal phalange of the digit. For those individuals with digits having a circumferential width that varies more or less uniformly along the length of the digit, a ring having an annular opening of a fixed size typically can be placed on the digit and removed therefrom with ease, while still ensuring that the ring fits snugly on the desired part of the digit.

However, many individuals possess digits that do not vary uniformly in width. For example, in some individuals, the joint connecting the intermediate phalange and the proximal phalange may be larger (sometimes substantially) than the average circumference of the proximal phalange. For these individuals, a ring having an annular opening of a fixed size that is chosen or designed to fit snugly around some portion of the proximal phalange may be difficult or impossible to slide past the substantially enlarged joint connecting the intermediate phalange and the proximal phalange. Moreover, in certain individuals, the joints connecting the various segments of a digit may vary in size as a result of medical conditions, also making it sometimes difficult or impossible to slide the ring onto and off of the digit with ease.

### SUMMARY

Embodiments of the invention are directed to rings that are structurally configured to allow a user/wearer of the ring to vary the size of the annular opening of the ring shank. A ring in accordance with embodiments of the invention comprises structural elements that allow the ring to be adjusted between a plurality of configurations in which the annular opening is large enough to permit a wearer to slide the ring past, for example, an enlarged joint, and a configuration in which the annular opening is narrowed and the ring is secured to the wearer's digit. In addition, the aforementioned structural elements include elements that both minimize rotation of the ring relative to the digit and provide comfort to the wearer. Embodiments of the invention are also directed to methods for making and using such rings.

In one or more embodiments of the invention, a ring comprises a ring shank and a clasp comprising a first end portion hingedly connected to the ring shank and a second end portion. The ring shank comprises inner and outer circumferential surfaces, the inner circumferential surface defining a maximum circumference of an annular opening of the ring. The clasp is rotatable relative to the ring shank between a secured position in which the second end portion is securably engaged with the ring shank and a plurality of unsecured positions.

In one or more embodiments of the invention, the clasp may comprise an arcuate portion extending between the first end portion and the second end portion, and at least one protrusion that comprises a contoured edge surface extending beyond an inner surface of the arcuate portion. In other embodiments, the at least one protrusion may comprise a contiguous structure adjoined to and integrally formed with the arcuate portion and having a same curvature as the arcuate portion. The first end portion, the second end portion, and the arcuate portion may constitute a single integrally formed structure. The at least one protrusion narrows a cross-sectional area of the annular opening of the ring when the second end portion of the clasp is engaged with the ring shank in the secured position. In a more specific embodiment, the at least one protrusion comprises a first protrusion that forms at least part of the first end portion of the clasp and a second protrusion that forms at least part of the second end portion of the clasp. The first protrusion and the second protrusion may be substantially symmetrically spaced from each other by the arcuate portion of the clasp. The first and second protrusions may each comprise contoured edge surfaces that contact a portion of a wearer's digit when the ring is placed on the wearer's digit and the second end portion of the clasp is engaged with the ring shank in the secured position. The contoured edge surfaces may be curved, rounded, semi-circular, arcuate, or any other regular or irregular shape. Moreover, the contoured edge surface of the first protrusion may be formed of a same or different contour or shape as that of the second protrusion. The contoured edge surfaces perform the dual function of providing comfort to the wearer and minimizing rotation of the ring relative to the wearer's digit.

A ring in accordance with one or more embodiments of the invention may further comprise first and second arcuate surfaces exposed within the ring shank by an aperture formed through a portion of the ring shank, and first and second projections that extend into the aperture from the first and second arcuate surfaces, respectively. The clasp is configured to rotate into the aperture until the secured position is reached, the secured position corresponding to a position in which the first and second projections are engaged in a receiving hole formed through a portion of the clasp. The clasp may further comprise an outer surface having a curvature substantially the same as that of the outer circumferential surface of the ring shank such that the outer surface is substantially flush with the outer circumferential surface when the second end portion of the clasp is engaged with the ring shank in the secured position. In certain embodiments, the clasp may comprise a tip that is raised from the outer circumferential surface of the ring shank when the second end portion of the clasp is engaged with the ring shank in the secured position. The tip enables a wearer/user of the ring to disengage the second end portion from the ring shank with ease.

The clasp may comprise a first elongated groove formed in a first surface of the clasp, and a second elongated groove formed in a second surface of the clasp, such that each of the grooves extend between the receiving hole of the clasp and an edge surface of the clasp. More specifically, in certain embodiments, the grooves may extend between the receiving hole and the contoured edge surface of the second protrusion. The first and second projections may be adapted to travel along and within the first and second elongated grooves, respectively, as the clasp is rotated into the aperture formed in the ring shank and until the second end portion of the clasp is engaged with the ring shank in the secured position by engagement of the first and second projections in the receiving hole.

A ring in accordance with one or more of the previously disclosed embodiments may further comprise one or more components integrally formed with the outer circumferential surface of the ring. The one or more components may be adapted to secure an object such as a gemstone to the ring.

In accordance with one or more embodiments of the invention, a method for forming a ring comprises providing or forming a ring shank comprising inner and outer circumferential surfaces, the inner circumferential surface defining a maximum circumference of an annular opening of the ring shank, providing or forming a clasp comprising a first end portion, a second end portion, and an arcuate portion extending between the first end portion and the second end portion, and hingedly connecting the first end portion of the clasp to the ring shank such that the clasp is rotatable relative to the ring shank between a secured position in which the second end portion of the clasp is securably engaged with the ring shank and a plurality of unsecured positions.

The clasp may be formed in accordance with any of the previously disclosed embodiments. The clasp may comprise at least one protrusion that comprises a contiguous structure adjoined to and integrally formed with the arcuate portion and having a same curvature as the arcuate portion. In alternative embodiments, the at least one protrusion may comprise a contoured edge surface extending beyond an inner surface of the arcuate portion. For example, the at least one protrusion may comprise a first protrusion that forms at least part of the first end portion and a second protrusion that forms at least part of the second end portion. The protrusions may be formed to have contoured edge surfaces that are curved, rounded, semi-circular, arcuate, or any other regular or irregular shape. The contoured edge surfaces perform the dual function of providing a suitable level of comfort to the wearer and minimizing rotation of the ring relative to the wearer's digit.

A method for forming a ring in accordance with one or more embodiments of the invention may further comprise forming an aperture through a portion of the ring shank, the aperture exposing first and second arcuate surfaces within the ring shank, and forming first and second projections that extend from the first and second arcuate surfaces, respectively.

The clasp may be separately provided in fully operational form, and subsequently hingedly connected to the ring shank. Alternatively, some or all structural aspects of the clasp may be formed as part of a method for forming a ring according to embodiments of the invention. For example, the method may further comprise forming a first elongated groove in a first surface of the clasp, forming a second elongated groove in a second surface of the clasp, and forming a receiving hole through the clasp such that the first and second elongated grooves extend between the receiving hole and an edge surface of the clasp. The grooves may be formed such that the first and second projections travel along and within the first and second elongated grooves, respectively, as the clasp is rotated into the aperture formed in the ring shank and until the second end portion of the clasp is engaged with the ring shank in the secured position by engagement of the first and second projections in the receiving hole.

A method for securing a ring having a construction in accordance with one or more of the previously disclosed embodiments to a digit of a wearer's hand comprises maintaining the clasp in one or more unsecured positions, sliding the ring along at least a portion of a length of the digit, and rotating the clasp towards the ring shank until the second end portion of the clasp is engaged with the ring shank in the secured position, wherein the at least one protrusion contacts a portion of the digit in the secured position.

These and other embodiments of the invention are described in detail with reference to the following drawings in the detailed description that follows.

### BRIEF DESCRIPTION OF THE DRAWINGS

FIG. 1A depicts a plan view of a ring in a first unsecured position in accordance with one or more embodiments of the invention.

FIG. 1B depicts a perspective view of the ring in the first unsecured position depicted in FIG. 1A.

FIG. 1C depicts an alternate perspective view of the ring in the first unsecured position depicted in FIG. 1A.

FIG. 1D depicts a plan view of a ring in an alternate unsecured position in accordance with one or more embodiments of the invention.

FIG. 1E depicts a perspective view of the ring in the alternate unsecured position depicted in FIG. 1D.

FIG. 1F depicts an alternate perspective view of the ring in the alternate unsecured position depicted in FIG. 1D.

FIG. 1G depicts a ring in the secured position in accordance with one or more embodiments of the invention.

FIG. 1H depicts a plan view of a ring in the secured position according to one or more alternate embodiments of the invention.

FIG. 2A depicts a ring in an unsecured position on a wearer's digit in accordance with one or more embodiments of the invention.

FIG. 2B depicts a ring in the secured position on a wearer's digit in accordance with one or more embodiments of the invention.

FIG. 3 depicts a process flow for forming a ring in accordance with one or more embodiments of the invention.

### DETAILED DESCRIPTION

Embodiments of the invention are directed to rings that are structurally configured so as to permit a wearer or user of the ring to vary the size or circumference of an annular opening of the ring. Embodiments of the invention are also directed to methods for making and using such rings.

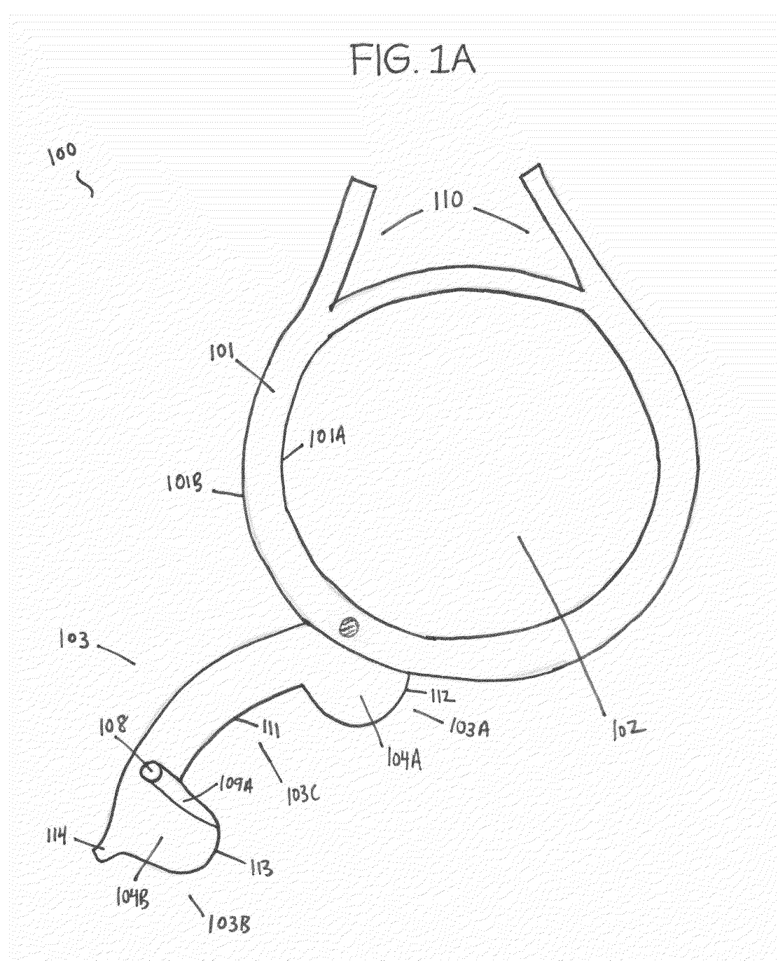

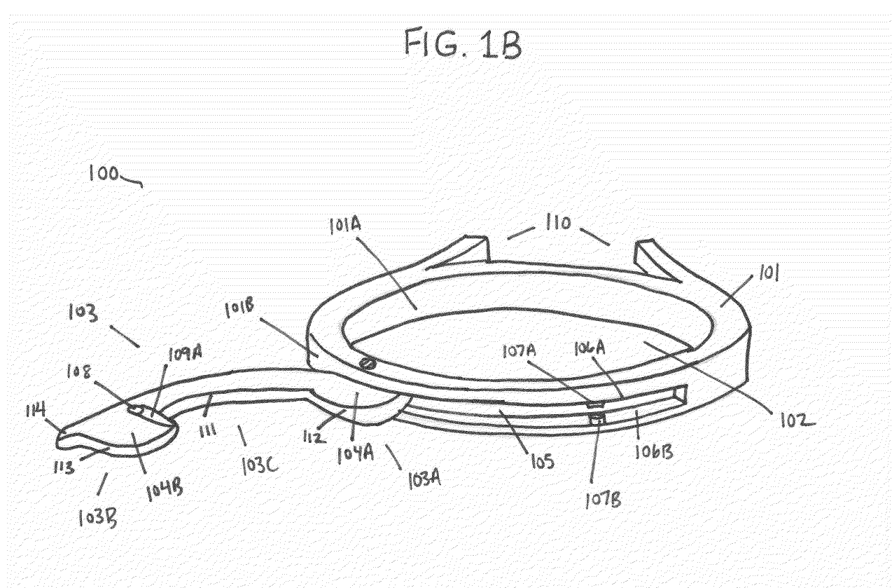

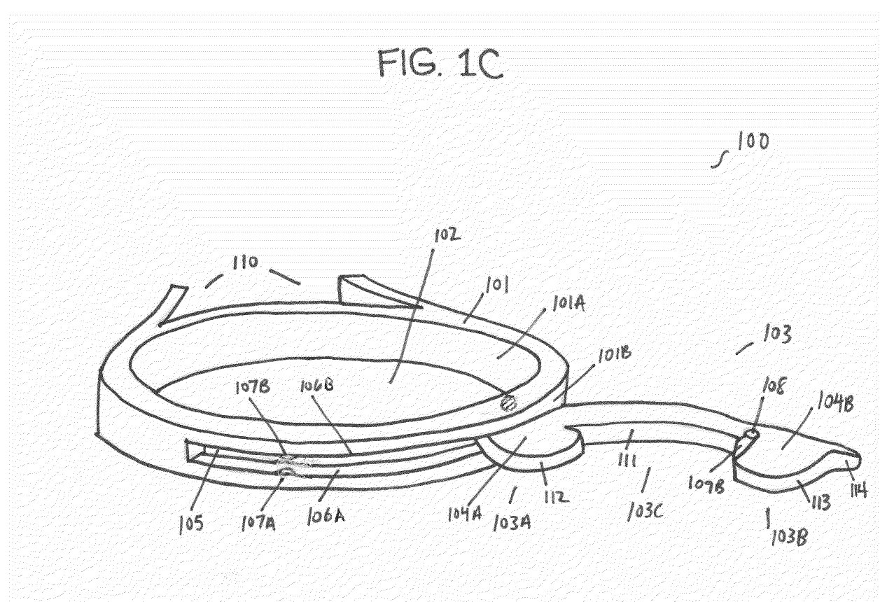

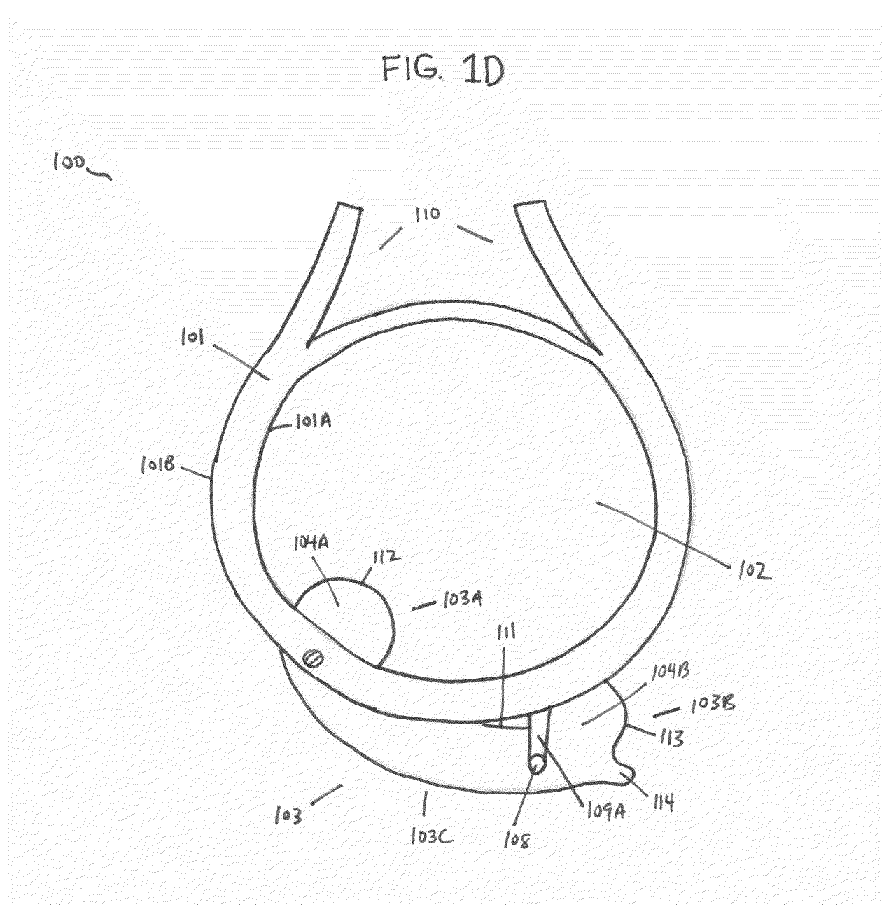

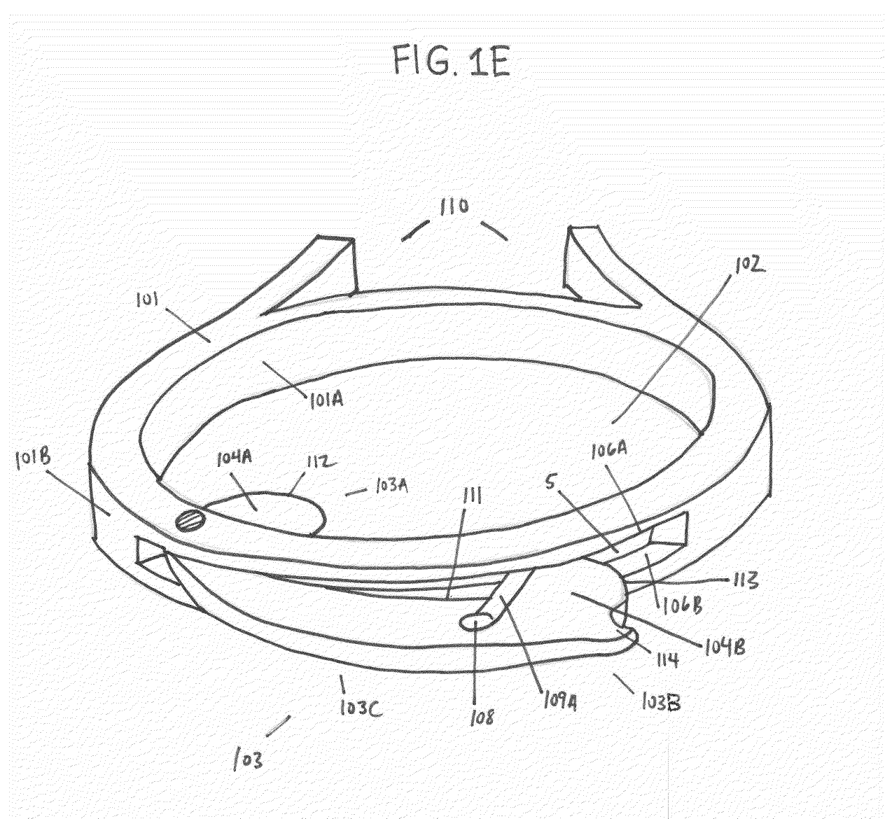

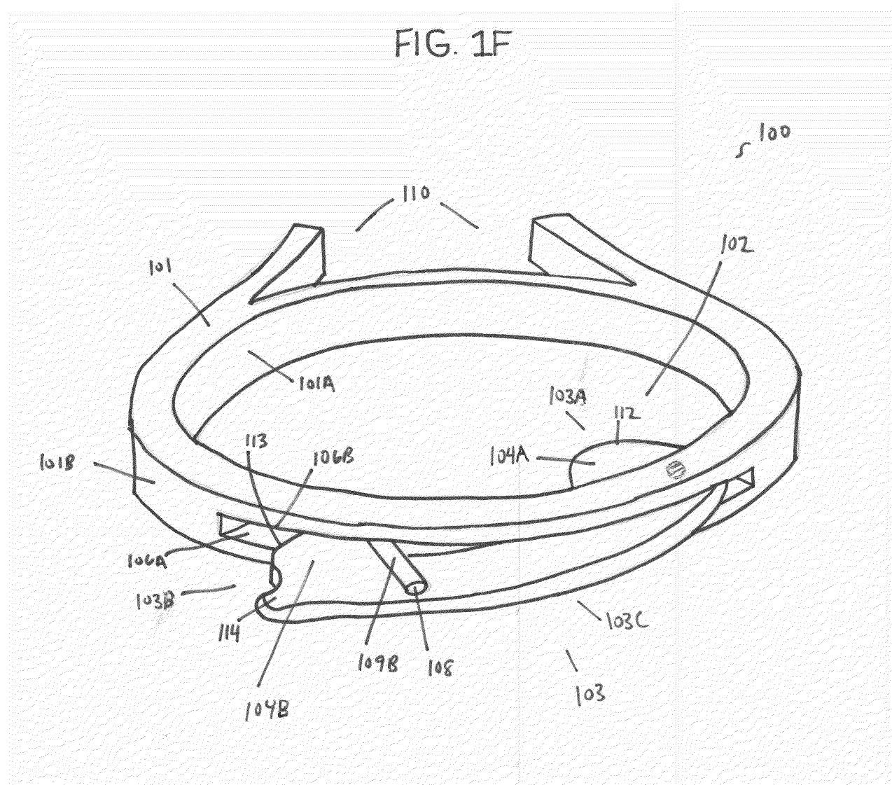

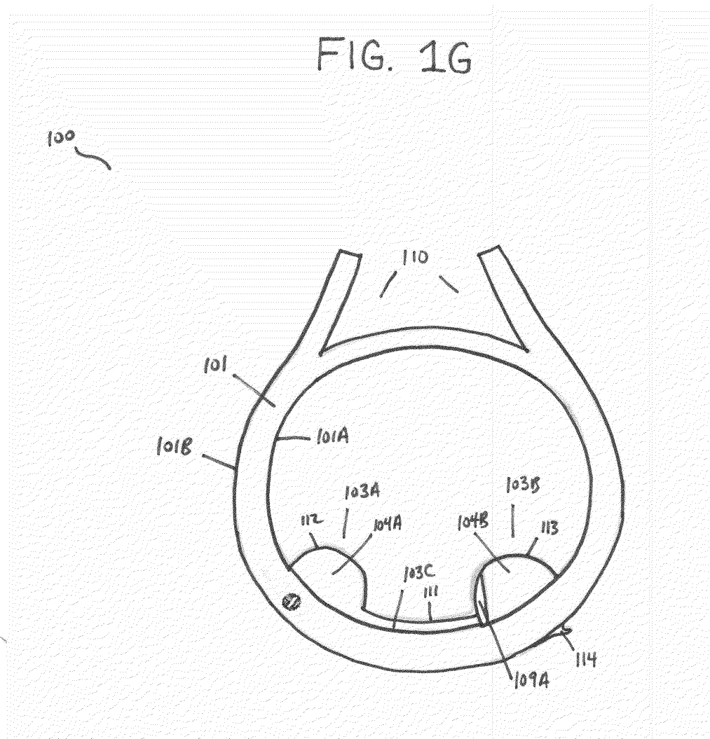

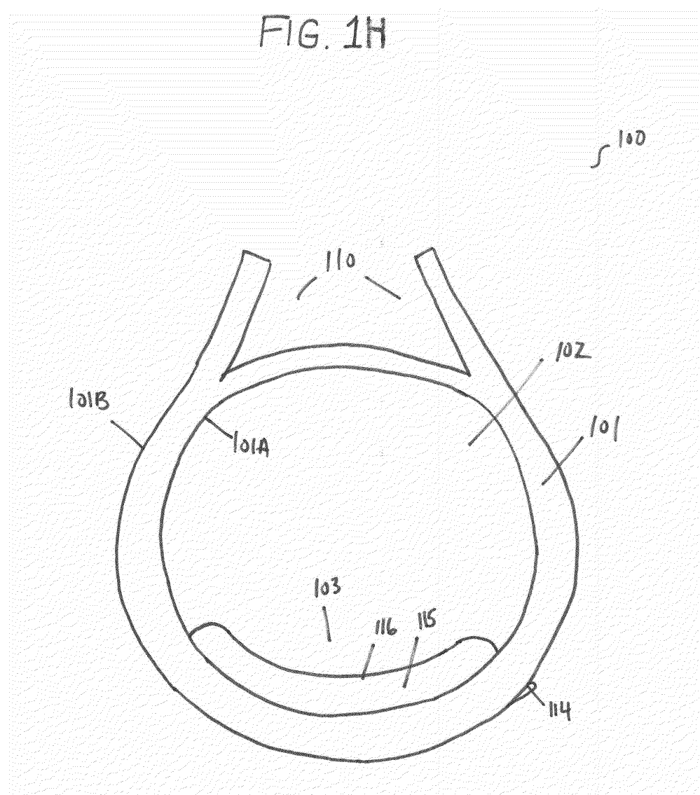

FIG. 1A depicts a ring 100 in a first unsecured position in accordance with an embodiment of the invention. Ring 100 comprises a ring shank 101 that comprises an inner circumferential surface 101A and an outer circumferential surface 101B. The ring 100 depicted in FIG. 1 also includes components 110 that are integrally formed with the outer circumferential surface 101A of the ring shank 101. These components 110 may be referred to in the art as a setting and may be adapted to secure an object such as a gemstone to the ring. The components 110 may be formed of any shape and may vary in number and spacing. Alternatively, the outer circumferential surface 101B may be free of any components that protrude therefrom.

The ring 100 further comprises a clasp 103 that includes a first end portion 103A, a second end portion 103B, and an arcuate portion 103C. In accordance with one or more embodiments of the invention, the clasp 103 may comprise at least one protrusion that comprises a contoured edge surface that extends beyond an inner surface of the arcuate portion 103C of the clasp. For example, in the embodiments depicted in FIGS. 1A-1G, the clasp 103 comprises a first protrusion 104A that forms at least part of the first end portion 103A of the clasp and a second protrusion 104B that forms at least part of the second end portion 103B of the clasp. In various embodiments of the invention, those portions of the clasp that correspond to the first end portion 103A, the second portion 103B and the arcuate portion 103C may vary. For example, in certain embodiments, the first end portion 103A may comprise the first protrusion 104A as well as a segment of the arcuate portion 103C. Similarly, the second end portion 103B of the clasp may comprise the second protrusion 104B as well as a segment of the arcuate portion 103C. Stated another way, in certain embodiments, some portions of the clasp depicted as part of the arcuate portion 103C in FIGS. 1A-1G may instead be thought of as part of the first end portion 103A or the second end portion 103B. In addition, in one or more embodiments, the clasp 103 may be integrally formed as a single piece such that the first end portion 103A and the second end portion 103B blend smoothly into the arcuate portion 103C. Moreover, as previously described, in other embodiments, the at least one protrusion may comprise a contiguous structure adjoined to or integrally formed with the arcuate portion and having a same curvature as the arcuate portion.

The first protrusion 104A and the second protrusion 104B comprise contoured edge surfaces 112, 113, respectively, that extend beyond an inner surface 111 of the arcuate portion 103C. The first end portion 103A of the clasp is hingedly connected to the ring shank 101 via any hinged mechanism known in the art such that the clasp 103 is rotatable with respect to the ring shank. The clasp 103 is rotatable relative to the ring shank 101 between a position in which the second end portion 103B of the clasp is securably engaged with the ring shank 101 (described in more detail hereinafter) and a plurality of unsecured positions.

The ring 100 shown in FIGS. 1A-1C is depicted in a first unsecured position in which the second end portion 103B of the clasp is farthest from the secured position. As the second end portion 103B of the clasp 103 is rotated towards the ring shank 101, the clasp 103 passes through a plurality of unsecured positions. In the first unsecured position shown in various views in FIGS. 1A-1C, no portion of the first protrusion 104A extends into the annular opening 102 of the ring 100. That is, in the first unsecured position depicted in FIGS. 1A-1C, the annular opening 102 of the ring 100 is at a maximum circumference, which is defined by a diameter of the inner circumferential surface 101A of the ring 100. As the clasp 103 is rotated towards the ring shank 101, and more specifically, as the second end portion 104B of the clasp 103 is rotated towards the ring shank 101, the clasp 103 passes through a plurality of continuous unsecured positions comprising an unsecured position in which the first protrusion 104A first enters the annular opening 102 and a series of additional unsecured positions in which the first protrusion 104A extends progressively farther into the annular opening 102.

As the clasp 103 is rotated towards the ring shank 101 through the plurality of continuous unsecured positions, an unsecured position may be reached in which the second end portion 103B of the clasp first contacts projections that extend from arcuate surfaces exposed within the ring shank 101 by an aperture formed therein (described in greater detail hereinafter through reference to FIGS. 1D-1F). From this unsecured position, the clasp 103 is further rotatable through additional unsecured positions towards the ring shank 101 and into the aperture until the secured position is reached.

FIG. 1B depicts a perspective view of the ring in the unsecured position depicted in FIG. 1A. In the view shown in FIG. 1B, additional structure that plays a role in securing the clasp 103 to the ring shank 101 is visible. As touched upon earlier, in accordance with one or more embodiments of the invention, an aperture 105 may be formed through a portion of the ring shank 101. The aperture 105 may extend through a portion of the inner circumferential surface 101A and a portion of the outer circumferential surface 101B. The aperture 105 may be formed, for example, in a bottom portion of the ring shank. First and second arcuate surfaces 106A, 106B may be exposed within the ring shank 101 by the aperture 105. A first projection 107A and a second projection 107B may extend from the first and second arcuate surfaces 106A, 106B, respectively. The first and second projections 107A, 107B may be integrally formed with the first and second arcuate surfaces 106A, 106B, respectively, or in the alternative, may be separately formed and affixed to the first and second arcuate surfaces 106A, 106B.

As shown in FIGS. 1A-1B for example, a first elongated groove 109A may be formed in a first surface of the clasp 103. Similarly, as shown in FIG. 1C for example, a second elongated groove 109B may be formed in a second surface of the clasp 103. Each of the first and second elongated grooves 109A, 109B may be formed so as to extend from a receiving hole 108 formed through a portion of the clasp 103. In the embodiments of the invention depicted in FIGS. 1A-1F, the first and second elongated grooves 109A, 109B extend between the receiving hole 108 and the contoured edge surface 113 of the second protrusion 104B. Depending on the embodiment, the receiving hole 108 may be formed through part of the second end portion 103B, through part of the arcuate portion 103C, or at an interface between the second end portion 103B and the arcuate portion 103C.

As noted earlier, FIGS. 1D-1F depict a ring in accordance with one or more embodiments of the invention in a different unsecured position than that depicted in FIGS. 1A-1C. The ring is shown in FIGS. 1D-1F in an unsecured position in which the second end portion 103B of the clasp 103—and more specifically the second protrusion 104B—first contacts the first and second projections 107A, 107B that extend from the first and second arcuate surfaces 106A, 106B, respectively. From the unsecured position depicted in FIGS. 1D-1F, in order to further rotate the clasp 103 into the aperture 105 formed in the ring shank 101, a user or wearer of the ring must exert a greater amount of force on the clasp 103 than is required to move the clasp 103 between the unsecured position depicted in FIGS. 1A-1C and the unsecured position depicted in FIGS. 1D-1F. In particular, a user or wearer must exert a force on the clasp 103 in a direction of rotation of the clasp 103 towards the ring shank 101 that is sufficient to overcome the frictional force exerted by the first and second elongated grooves 109A, 109B against the first and second projections 107A, 107B as each projection travels through its respective groove. A user or wearer will generally exert the required force towards the second end portion 103B of the clasp 103 in order to generate greater torque on the clasp 103.

As the clasp 103 is rotated further into the aperture 105 from the alternate unsecured position depicted in FIGS. 1D-1F, the first and second projections 107A, 107B travel along and within the first and second elongated grooves 109A, 109B, respectively, causing the clasp 103 to pass through a series of additional unsecured positions. Ultimately, the first and second projections 107A, 107B reach the receiving hole 108 and are engaged therein. The secured position corresponds to a position in which the first and second projections 107A, 107B are engaged in the receiving hole 108 and the second end portion 103B is securably engaged with the ring shank 101.

A plan view of a ring in the secured position according to one or more embodiments of the invention is shown in FIG. 1G. In the secured position depicted in FIG. 1G, the first protrusion 104A and the second protrusion 104B extend farther into the annular opening 102 of the ring than in any of the unsecured positions. Moreover, in the secured position, part of the arcuate portion 103C may also extend into the annular opening 102 (as shown in FIG. 1F) and an outer surface of the arcuate portion 103C may be substantially flush with the outer circumferential surface 101B of the ring shank 101. In alternative embodiments, no part of the arcuate portion 103C extends into the annular opening when the second end portion 103B is engaged with the ring shank 101 in the secured position.

FIG. 1H depicts a ring in the secured position accordance with one or more alternate embodiments of the invention. As in previously described embodiments, the ring 100 comprises a ring shank 101 having an annular opening 102 and inner and outer circumferential surfaces 101A, 101B. The ring 100 comprises a clasp 103, which in turn comprises a contiguous structure 115 having a substantially arcuate shape. The contiguous structure 115 may be thought of as being adjoined to or integrally formed with an arcuate portion of the clasp and as having a same curvature as the arcuate portion. The contiguous structure 115 comprises a concave surface 116 designed to sit substantially flush with the convex surface of a wearer's digit when the ring is in the secured position on the digit. The contiguous structure 115, and in particular the concave surface 116 thereof, provide similar advantages (e.g. comfort to the wearer and minimization of rotation of the ring relative to the wearer's digit) as those provided by the first and second protrusions of alternate embodiments of the invention.

When the ring depicted in various embodiments in FIGS. 1A-1G is secured on a wearer's digit, the first and second protrusions 104A, 104B produce significant advantages over conventional rings including minimizing rotation of the ring relative to the wearer's digit while at the same time providing a suitable level of comfort for the wearer. In particular, the contoured edge surfaces 112, 113 of the first and second protrusions 104A, 104B, respectively, are formed so as to provide the wearer with a level of comfort that is comparable to that provided by a conventional ring or band having an annular opening of a fixed size. Further, the spacing and curvature of the first and second protrusions 104A, 104B minimizes the tendency for the ring to rotate relative to the wearer's digit. The clasp 103 may further comprise a tip 114 that allows a user to disengage the second end portion 103B of the clasp 103 from the secured position and further rotate the second end portion away from the ring shank 101. More specifically, a user may exert a force on the tip 114 sufficient to disengage the first and second projections 107A, 107B from the receiving hole 108 and rotate the clasp 103 from the secured position to one or more of the unsecured positions.

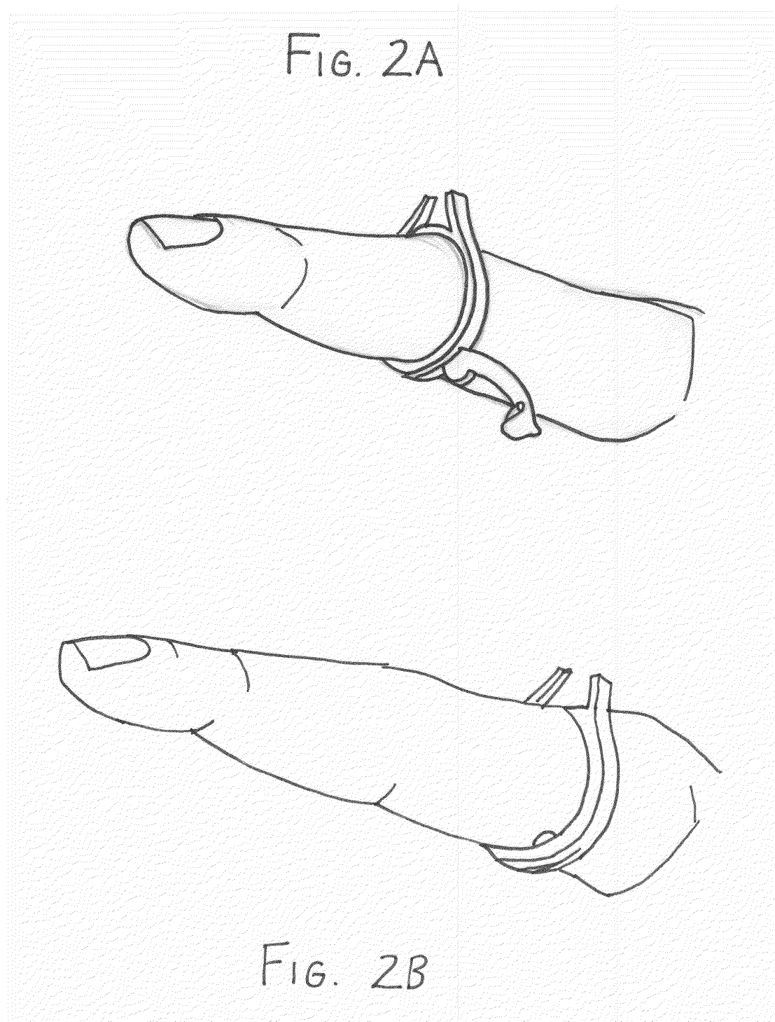

FIGS. 2A and 2B depict a ring according to embodiments of the invention in an unsecured position and the secured position, respectively, at different positions along the length of a wearer's digit. As shown in FIG. 2A, the ring may be maintained in one or more unsecured positions in which the annular opening is large enough to accommodate the cross-sectional circumference of the digit as the ring is slid onto and along the digit. As shown in FIG. 2B, and referring to FIGS. 1A-1G, upon reaching a location on the digit where the user desires to secure the ring, the clasp 103 may be rotated towards the ring shank 101 and into the aperture 105 (as described in detail earlier) until the first and second projections 107A, 107B are engaged in the receiving hole 108 and the second end portion 104B of the clasp 103 is securably engaged with the ring shank 101 in the secured position. In the secured position, the first and second protrusions 104A, 104B extend farther into the annular opening 102 than in any of the unsecured positions and the cross-sectional area of the annular opening 102 capable of accommodating the wearer's digit is at a minimum.

In this manner, the wearer is able to slide the ring past enlarged portions of the digit by maintaining the ring in one or more unsecured positions, and subsequently secure the ring to a portion of the digit having a smaller cross-sectional circumference by securing the second end portion 103B of the clasp 103 to the ring shank 101 in the secured position. In the embodiments of the invention depicted in FIGS. 1A-1G, the secured position corresponds to a position in which the first and second protrusions 104A, 104B are engaged in the receiving hole 108 and narrow the size of the annular opening 102 to such an extent that the ring fits snugly on the desired portion of the digit.

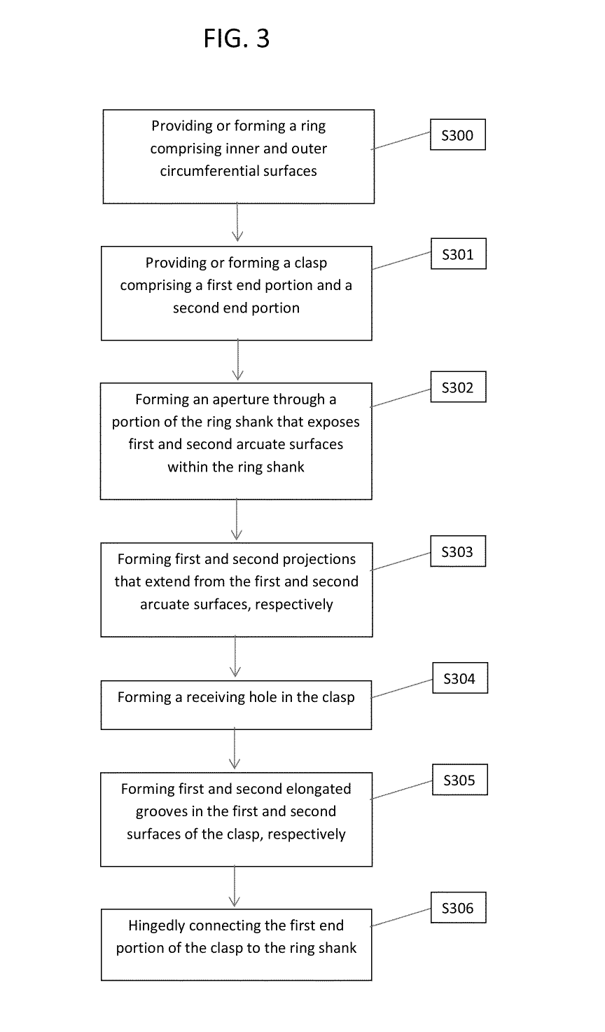

FIG. 3 depicts a process flow for forming a ring in accordance with one or more embodiments of the invention. In step S300, a ring comprising a ring shank having inner and outer circumferential surfaces is provided or formed, where the inner circumferential surface defines a maximum circumference of an annular opening of the ring shank. In step S301, a clasp comprising a first end portion and a second end portion is separately provided or formed as part of the method.

The clasp may be formed in accordance with any of the previously disclosed embodiments. For example, the clasp may comprise an arcuate portion extending between the first end portion and the second end portion and at least one protrusion. The at least one protrusion may comprise a contoured edge surface extending beyond an inner surface of the arcuate portion. In various embodiments, the at least one protrusion may comprise a first protrusion that forms at least part of the first end portion and a second protrusion that forms at least part of the second end portion. The protrusions may be formed to have contoured edge surfaces that are curved, rounded, semi-circular, arcuate, or alternate regular or irregular shapes. The contoured edge surfaces perform the dual function of providing a suitable level of comfort to the wearer and minimizing rotation of the ring relative to the wearer's digit.

As previously noted, the clasp may be separately provided in fully operational form, and subsequently hingedly connected to the ring shank. Alternatively, some or all structural aspects of the clasp may be formed as part of a method for forming a ring according to embodiments of the invention. For example, in certain embodiments, a clasp comprising a first end portion comprising a first protrusion, a second end portion comprising a second protrusion, and an arcuate portion extending between the first end portion and the second end portion may be formed as part of the above-described method or may be separately provided. The second end portion of the clasp may be formed to have a tip to assist in disengaging the clasp from the secured position as previously described.

The method may further comprise, in step S302, forming an aperture through a portion of the ring shank, the aperture exposing first and second arcuate surfaces within the ring shank, and, in step S303, forming first and second projections that extend from the first and second arcuate surfaces, respectively.

In step S304, a receiving hole may be formed through the clasp. In step S305, first and second elongated grooves may be formed in first and second surfaces of the clasp, respectively. The first and second elongated grooves may be formed so as to extend between the receiving hole and the contoured edge surface of the second end portion of the clasp. Finally, in step S306, the first end portion of the clasp may be hingedly connected to the ring shank such that the clasp is rotatable with respect to the ring shank. As the clasp, and more specifically the second end portion of the clasp, is rotated towards the ring into the aperture formed in the ring shank, the first and second projections are adapted to travel along and within the first and second elongated grooves, respectively, until the second end portion of the clasp is engaged with the ring shank in the secured position and the first and second projections are engaged in the receiving hole.

Other embodiments are within the scope of the invention beyond those described above. For example, the clasp may have a multitude of shapes and configurations and may include any number of protrusions. The protrusion(s) may be a single, contiguous structure having a curvature substantially the same as an arcuate portion of the clasp (as shown in FIG. 1G). Alternatively, the protrusion(s) may have contoured edge surfaces that extend beyond an inner surface of the arcuate portion of the clasp. The protrusion(s) may be formed to have any regular or irregular shape so long as the protrusion(s) are capable of narrowing a cross-sectional area of the annular opening of the ring. The first and second end portions of the clasp may be formed of any shape and the arcuate portion may be formed of any desired length. Moreover, while embodiments of the invention have been described with respect to a securing mechanism that comprises a clasp and first and second projections that extend into an aperture formed within the body of the ring shank and that engage a receiving hole formed in the clasp in order to secure the clasp to the ring shank, other securing mechanisms are within the scope of the invention. Any means for securing to the ring shank structure that variably narrows the annular opening of the ring may be employed.

The above-described embodiments have been presented purely for exemplary purposes. The scope of the invention is determined solely by the claims that follow read in light of other portions of the specification and common knowledge in the art. The invention is not limited solely to the described embodiments, which are included to enable a person having ordinary skill in the art to make and use the invention when combined with information and knowledge available to the person having ordinary skill in the art.

1. A ring comprising:
a ring shank comprising inner and outer circumferential surfaces, the inner circumferential surface defining a maximum circumference of an annular opening of the ring shank, the ring shank having an aperture formed through a portion thereof, the aperture exposing first and second arcuate surfaces within the ring shank;
a clasp comprising a first end portion hingedly connected to the ring shank and a second end portion, a first elongated groove being formed in a first surface of the clasp and a second elongated groove being formed in a second surface of the clasp, the first and second elongated grooves extending between a receiving hole formed through a portion of the clasp and an edge surface of the clasp; and
first and second projections extending into the aperture from the first and second arcuate surfaces, respectively,
wherein the clasp is rotatable relative to the ring shank between a secured position in which the second end portion is securably engaged with the ring shank and a plurality of unsecured positions, wherein the first and second projections are adapted to travel along and within the first and second elongated grooves, respectively, as the clasp is rotated into the aperture formed in the ring shank and until the second end portion of the clasp is engaged with the ring shank in the secured position, and wherein the secured position corresponds to a position in which the first and second projections are engaged in the receiving hole.

2. The ring of claim 1, wherein the clasp further comprises:
an arcuate portion extending between the first end portion and the second end portion, and
at least one protrusion having a contoured edge surface extending beyond an inner surface of the arcuate portion.

3. The ring of claim 2, wherein the at least one protrusion narrows a cross-sectional area of the annular opening of the ring when the second end portion of the clasp is engaged with the ring shank in the secured position.

4. The ring of claim 3, wherein the at least one protrusion comprises:
a first protrusion that forms at least part of the first end portion of the clasp, and
a second protrusion that forms at least part of the second end portion of the clasp.

5. The ring of claim 4, wherein the first protrusion and the second protrusion are substantially symmetrically spaced from each other by the arcuate portion of the clasp.

6. The ring of claim 4, wherein the first protrusion and the second protrusion each comprise respective curved edge surfaces that contact a digit of a wearer of the ring when the ring is placed on the digit and when the second end portion of the clasp is engaged with the ring shank in the secured position.

7.-8. (canceled)

9. The ring of claim 1, the clasp comprising:
an outer surface that is substantially flush with the outer circumferential surface of the ring shank when the second end portion of the clasp is engaged with the ring shank in the secured position; and
a tip that enables a user of the ring to disengage the second end portion of the clasp from the secured position.

10. A ring, comprising:
a ring shank comprising inner and outer circumferential surfaces, the inner circumferential surface defining a maximum circumference of an annular opening of the ring shank; and
a clasp comprising a first end portion hingedly connected to the ring shank, a second end portion, and an arcuate portion extending between the first end portion and the second end portion, the clasp being rotatable relative to the ring shank between a secured position in which the second end portion is securably engaged with the ring shank and a plurality of unsecured positions,
wherein the clasp comprises at least one protrusion having a contoured edge surface extending beyond an inner surface of the arcuate portion, the at least one protrusion comprising a contiguous structure adjoined to and extending from the arcuate portion and having substantially the same curvature as the arcuate portion, the contiguous structure comprising a concave edge surface.

11. A method for forming a ring comprising:
providing or forming a ring shank comprising inner and outer circumferential surfaces, the inner circumferential surface defining a maximum circumference of an annular opening of the ring shank;
forming an aperture through a portion of the ring shank, the aperture exposing first and second arcuate surfaces within the ring shank;
forming first and second projections that extend from the first and second arcuate surfaces, respectively;
providing or forming a clasp comprising a first end portion and a second end portion;
forming a receiving hole through a portion of the clasp,
forming a first elongated groove in a first surface of the clasp and a second elongated groove in a second surface of the clasp, the first and second elongated grooves extending between the receiving hole of the clasp and an edge surface of the clasp; and
hingedly connecting the first end portion of the clasp to the ring shank,
wherein the clasp is rotatable relative to the ring shank between a secured position in which the second end portion is securable engaged with the ring shank and a plurality of unsecured positions, wherein the first and second projections are adapted to travel along and within the first and second elongated grooves, respectively, as the clasp is rotated into the aperture formed in the ring shank and until the second end portion of the clasp is engaged with the ring shank in the secured position, and wherein the secured position corresponds to a position in which the first and second projections are engaged in the receiving hole.

12. The method of claim 11, wherein the clasp comprises:
an arcuate portion extending between the first end portion and the second end portion,
at least one protrusion comprising a contoured edge surface that extends beyond an inner surface of the arcuate portion.

13. The method of claim 12, wherein the at least one protrusion narrows a cross-sectional area of the annular opening of the ring when the second end portion of the clasp is engaged with the ring shank in the secured position.

14. The method of claim 13, wherein the at least one protrusion comprises a first protrusion that forms part of the first end portion of the clasp and a second protrusion that forms part of the second end portion of the clasp.

15. The method of claim 14, wherein the first protrusion and the second protrusion are symmetrically spaced from each other by the arcuate portion of the clasp.

16. The method of claim 14, wherein the first protrusion and the second protrusion each comprise respective curved edge surfaces that contact a digit of a wearer of the ring when the ring is placed on the digit and when the second end portion of the clasp is engaged with the ring shank in the secured position.

17.-19. (canceled)

20. A method for securing the ring of claim 2 to a digit of a hand, the method comprising:
maintaining the clasp in one or more unsecured positions;
sliding the ring along at least a portion of a length of the digit;
rotating the clasp relative to the ring shank until the second end portion of the clasp is engaged with the ring shank in the secured position, wherein the at least one protrusion contacts a portion of the digit in the secured position.

21. A method for securing the ring of claim 10 to a digit of a hand, the method comprising:
maintaining the clasp in one or more unsecured positions;
sliding the ring along at least a portion of a length of the digit;
rotating the clasp relative to the ring shank until the second end portion of the clasp is engaged with the ring shank in the secured position, wherein the at least one protrusion contacts a portion of the digit in the secured position.
